(19) United States
(12) Patent Application Publication
(10) Pub. No.: US 2014/0340517 A1
(43) Pub. Date: Nov. 20, 2014

(54) VEHICLE DATA RECORDER, VEHICLE DATA RECORDER SYSTEM AND EMPLOYING METHOD FOR THE VEHICLE DATA RECORDER SYSTEM

(71) Applicants: FIH (HONG KONG) LIMITED, Kowloon (HK); SHENZHEN FUTAIHONG PRECISION INDUSTRY CO., LTD., Shenzhen (CN)

(72) Inventor: JIAN-HUI LI, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/017,434

(22) Filed: Sep. 4, 2013

(30) Foreign Application Priority Data
May 16, 2013 (CN) 2013101801074

(51) Int. Cl. H04N 7/18

(52) U.S. Cl. CPC H04N 7/18
USPC 348/148

(57) ABSTRACT

A vehicle data recorder fixed to a pair of glasses includes a main body and a fixing element. The main body includes a main portion, a connection rod, and an earphone. The main portion is connected to the connection rod, and the earphone extends from a free end of the connection rod. The fixing element is fixed to the main portion, and a free end of the fixing element is spaced from the main portion. The vehicle data recorder is fixed to the glasses with the fixing element.

### BACKGROUND

1. Technical Field

The disclosure generally relates to vehicle data recorders and more particularly to a vehicle data recorder capable of recording a wide range of data, a vehicle data recorder system and an employing method for the vehicle data recorder system.

2. Description of the Related Art

Vehicle data recorders record data associated with a vehicle's driving status and then people can analyze the cause of an emergency by the use of recorded data. Generally, the vehicle data recorder is located on a front window of the vehicle, and a view angle of the vehicle data recorder is about 100 degrees. The vehicle data recorder must be fixed in place and the recording range of the vehicle data recorder is limited.

Therefore, there is room for improvement within the art.

### BRIEF DESCRIPTION OF THE DRAWINGS

Many aspects of an exemplary vehicle data recorder can be better understood with reference to the following drawings. The components in the drawings are not necessarily drawn to scale, the emphasis instead being placed upon clearly illustrating the principles of the exemplary vehicle data recorder. Moreover, in the drawings, like reference numerals designate corresponding parts throughout the several views. Wherever possible, the same reference numbers are used throughout the drawings to refer to the same or like elements of an exemplary embodiment.

FIG. 1 is a schematic view of a vehicle data recorder according to a first exemplary embodiment of the disclosure.

FIG. 2 is an exploded view of the vehicle data recorder shown in FIG. 1.

FIG. 3 is a partially assembled view of the vehicle data recorder in use.

FIG. 4 is a block diagram of a vehicle data recorder system, according to an exemplary embodiment of the disclosure.

FIG. 5 is a flowchart illustrating an employing method for the vehicle data recorder system shown in FIG. 4.

FIG. 6 is an exploded view of a vehicle data recorder according to a second exemplary embodiment of the disclosure.

### DETAILED DESCRIPTION

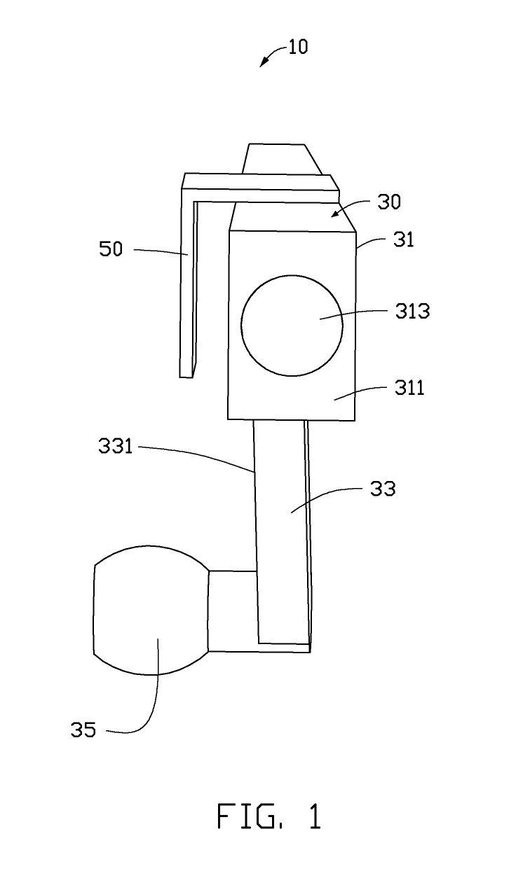

FIG. 1 shows a vehicle data recorder 10 according to a first exemplary embodiment of the disclosure. The vehicle data recorder 10 includes a main body 30 and a fixing element 50. The fixing element 50 is fixed to the main body 30, and a free end of the fixing element 50 is spaced from the main body 30.

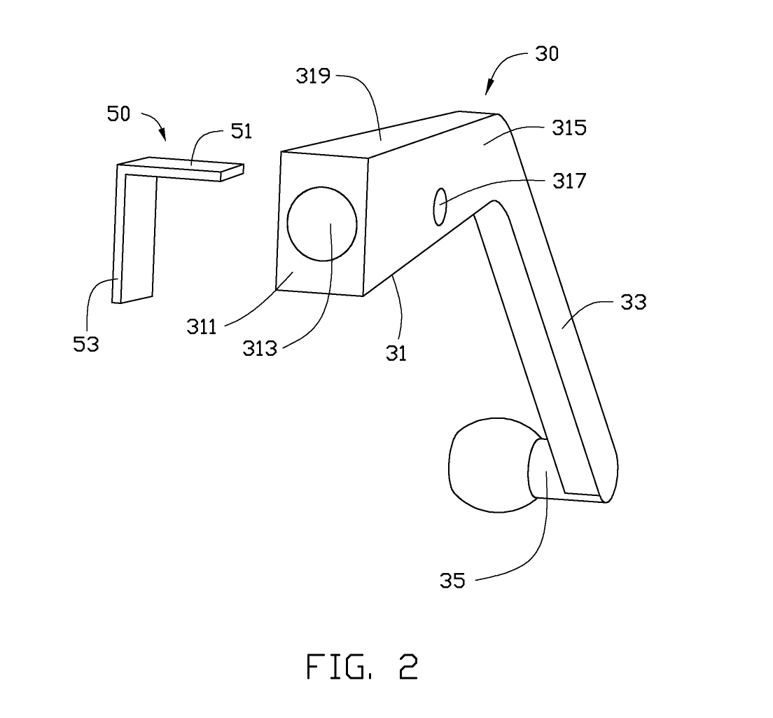

FIG. 2 shows that the main body 30 including a main portion 31, a connection rod 33, and an earphone 35. The main portion 31 is connected to the connection rod 33, and in this exemplary embodiment, an angle between the main portion 31 and the connection rod 33 is an obtuse angle. The earphone 35 extends from a free end of the connection rod 33 and the earphone 35 is perpendicular to an inner side surface 331 of the connection rod 33.

In the exemplary embodiment, the main portion 31 is a substantially trapezoidal pyramid, and includes an end wall 311, a peripheral wall 315 and a top wall 319 connected to the peripheral wall 315. The peripheral wall 315 and the top wall 319 are respectively connected to the end wall 311. A camera 313 is located on the end wall 311. A button 317 is located on the peripheral wall 315.

The fixing element 50 is substantially L-shaped and includes a fixing portion 51 and an elastic portion 53. The fixing portion 51 is perpendicularly connected to the elastic portion 53. The elastic portion 53 is made of elastic material, and in this exemplary embodiment, the elastic portion 53 is made of flexible metallic material. The fixing portion 51 is fixed to the top wall 319 with glue, and then the elastic portion 53 is spaced from the main portion 31 (shown in FIG. 1).

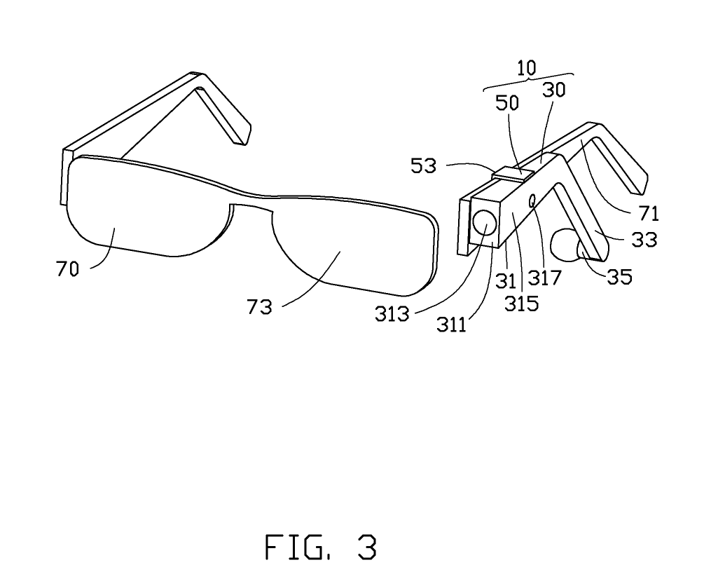

FIG. 3 shows that in use, the vehicle data recorder 10 can be attached to an arm 71 of a pair of glasses 70. The interval between the elastic portion 53 and the main portion 31 is smaller than the thickness of the arm 71. In assembly, the elastic portion 53 is slightly pulled away from the main portion 31, and the arm 71 is inserted between the elastic portion 53 and the main portion 31. An end of the arm 71 connected to a lens 73 of the glasses 70 is coplanar with the end wall 311. The elastic portion 53 is released and resists the arm 71 under the elastic restoring force of the elastic portion 53. The arm 71 is clamped between the elastic portion 53 and the main portion 31 and the vehicle data recorder 10 is fixed to the glasses 70.

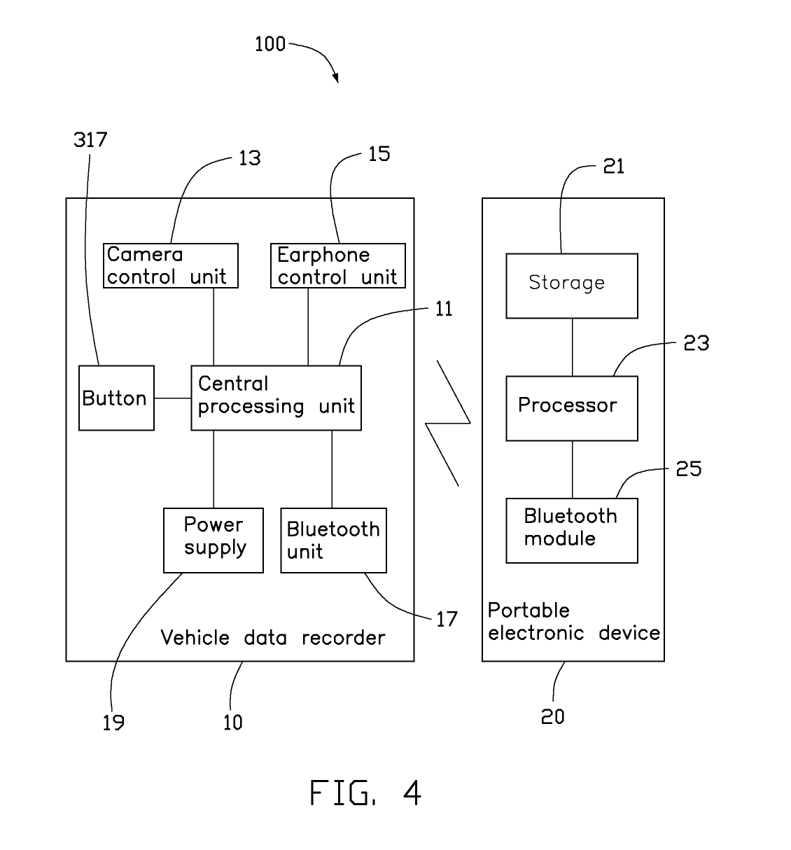

FIG. 4 shows that a vehicle data recorder system 100 includes the vehicle data recorder 10 and a portable electronic device 20. The portable electronic device 20 can be a mobile phone, and/or a personal digital assistant with Bluetooth function. The vehicle data recorder 10 further includes a central processing unit (CPU) 11, a camera control unit 13, an earphone control unit 15, a Bluetooth unit 17, and a power supply 19. The CPU 11, the camera control unit 13, the earphone control unit 15, the Bluetooth unit 17 and the power supply 19 are received in the main portion 31. The button 317, the camera control unit 13, the earphone control unit 15, the Bluetooth unit 17 and the power supply 19 are electronically connected to the CPU 11.

When the button 317 is pressed, the power supply 19 supplies power to the vehicle data recorder 10. The camera control unit 13 allows the camera 313 to record videos under the control of the CPU 11. The camera control unit 13 converts the videos into electrical signals and sends the electrical signals to the CPU 11. The CPU 11 sends the electrical signals to the Bluetooth unit 17. The Bluetooth unit 17 converts the electrical signals into Bluetooth signals and transmits the Bluetooth signals. The Bluetooth unit 17 can also receive Bluetooth signals transmitted by the portable electronic device 20 and send the Bluetooth signals to the CPU 11. The earphone control unit 15 allows the earphone 35 to sound corresponding to the Bluetooth signals received by the Bluetooth unit 17 under the control of the CPU 11, and then the vehicle data recorder 10 is used as a Bluetooth earphone.

The portable electronic device 20 includes a storage 21, a processor 23, and a Bluetooth module 25. The storage 21 and the Bluetooth module 25 are electronically connected to the processor 23. The Bluetooth module 25 receives Bluetooth signals transmitted by the Bluetooth unit 17, converts the Bluetooth signals into electrical signals and sends the electrical signals to the processor 23. The processor 23 converts the electrical signals into video, and the video is stored in the storage 21.

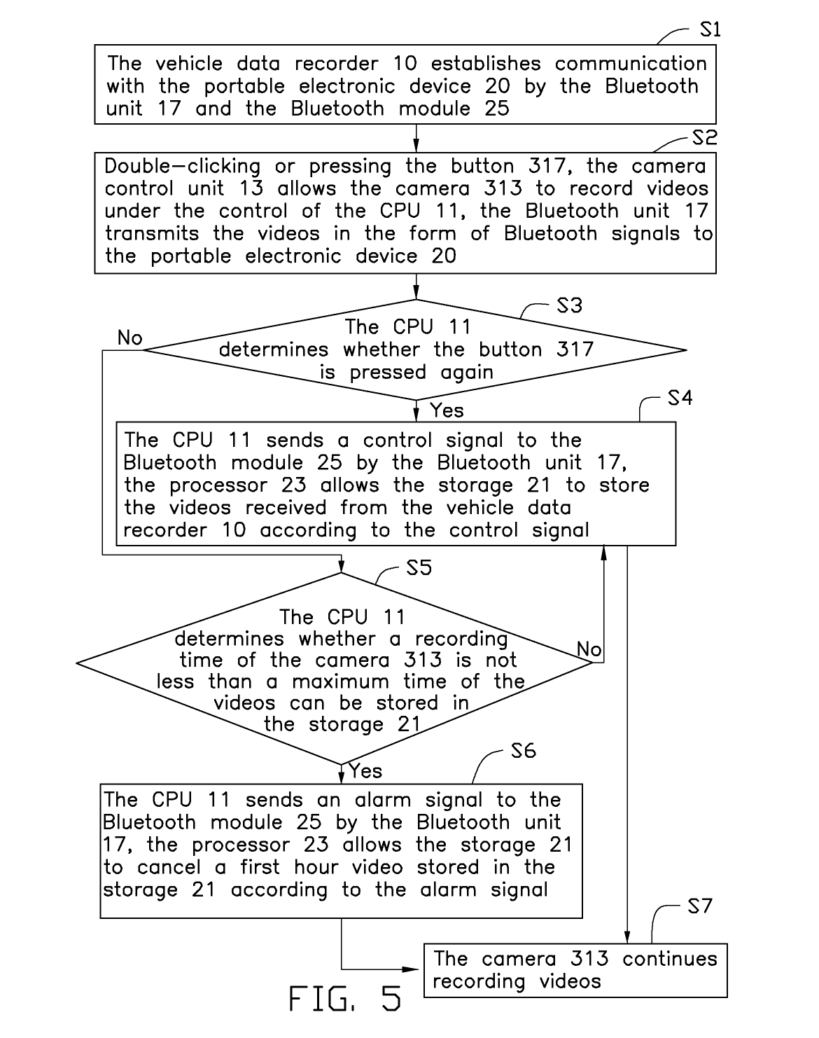

FIG. 5 shows a flowchart illustrating a working process of the vehicle data recorder system 100. A user wears the glasses 70 with the vehicle data recorder 10 and presses the button 317.

In step S1, the vehicle data recorder 10 establishes communication with the portable electronic device 20 by the Bluetooth unit 17 and the Bluetooth module 25.

In step S2, double-clicking or pressing the button 317, the camera control unit 13 allows the camera 313 to record videos under the control of the CPU 11, the Bluetooth unit 17 transmits the videos in the form of Bluetooth signals to the portable electronic device 20.

In step S3, the CPU 11 determines whether the button 317 is pressed again, if the button 317 is pressed again, step S4 is ran. If the button 317 is not pressed again, step S5 is ran.

In step S4, the CPU 11 sends a control signal to the Bluetooth module 25 by the Bluetooth unit 17. The Bluetooth module 25 sends the control signal to the processor 23 and the processor 23 allows the storage 21 to store the videos received from the vehicle data recorder 10 according to the control signal.

In step S5, the CPU 11 determines whether a recording time of the camera 313 is not less than N (N>0). N is determined by the storage space of the storage 21 and is pre-stored in the CPU 11. N can also refer to a maximum time of the videos that can be stored in the storage 21. For example, the storage 21 may only store a three-hour video, then N=3. If the recording time of the camera 313 is not less than N, step S6 is ran. If the recording time of the camera 313 is less than N, step S4 is ran.

In step S6, the CPU 11 sends an alarm signal to the Bluetooth module 25 by the Bluetooth unit 17. The Bluetooth module 25 sends the alarm signal to the processor 23 and the processor 23 allows the storage 21 to cancel a first hour video stored in the storage 21 according to the alarm signal.

In step S7, the camera 313 continues recording videos.

The vehicle data recorder 10 is easily fixed to the glasses 70, and the recording range of the vehicle data recorder 10 is an area within the field of vision of the user. The vehicle data recorder 10 has simple structure and is convenient to use. The vehicle data recorder 10 can also be used as a Bluetooth earphone.

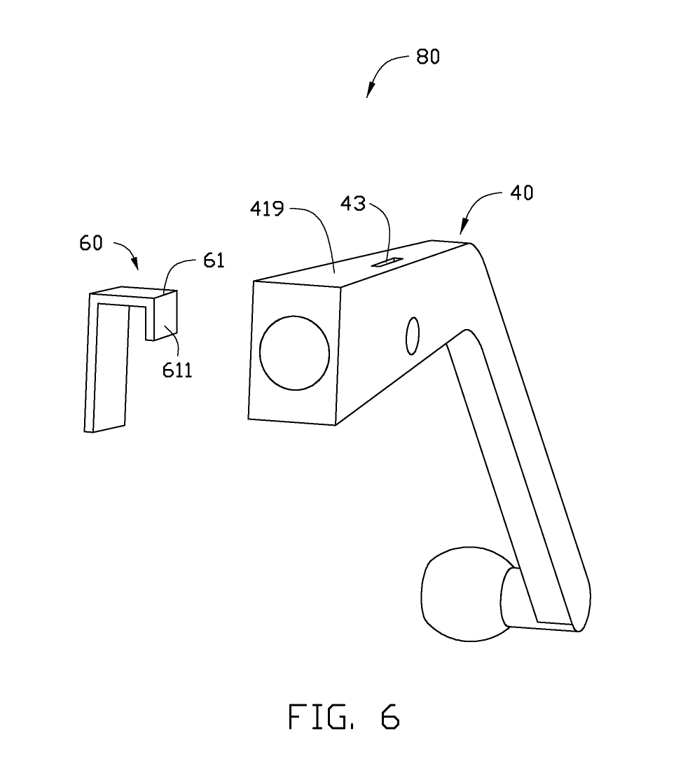

FIG. 6 shows a vehicle data recorder 80 according to a second exemplary embodiment of the disclosure. The vehicle data recorder 80 is similar to the above-described vehicle data recorder 10, differing in that a latching portion 611 extends from a free end of a fixing portion 61 of a fixing element 60. The latching portion 611 is perpendicular to the fixing portion 61. A top wall 419 of a main body 40 defines a groove 43, and the latching portion 611 is received in the groove 43.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A vehicle data recorder fixed to a pair of glasses, the vehicle data recorder comprising:
a main body comprising a main portion, a connection rod, and an earphone, the main portion connected to the connection rod, the earphone extending from a free end of the connection rod; and
a fixing element fixed to the main portion;
wherein a free end of the fixing element is spaced from the main portion and the vehicle data recorder is fixed to the glasses by the fixing element.

2. The vehicle data recorder as claimed in claim 1, wherein the fixing element comprises a fixing portion and an elastic portion, the fixing portion is perpendicularly connected to the elastic portion.

3. The vehicle data recorder as claimed in claim 2, wherein the elastic portion is made of elastic material.

4. The vehicle data recorder as claimed in claim 2, wherein the fixing portion is fixed to the main portion, and the elastic portion is spaced from the main portion.

5. The vehicle data recorder as claimed in claim 1, wherein an angle between the main portion and the connection rod is an obtuse angle, the earphone extends from a free end of the connection rod and the earphone is perpendicular to an inner side surface of the connection rod.

6. The vehicle data recorder as claimed in claim 1, wherein the main portion comprises an end wall and a peripheral wall connected to the peripheral wall; a camera is located on the end wall and a button is located on the peripheral wall.

7. The vehicle data recorder as claimed in claim 6, further comprising a central processing unit (CPU), a camera control unit, an earphone control unit, and a Bluetooth unit; wherein the CPU, the camera control unit, the earphone control unit, and the Bluetooth unit are received in the main portion; the button, the camera control unit, the earphone control unit, and the Bluetooth unit are electronically connected to the CPU.

8. The vehicle data recorder as claimed in claim 7, wherein when the button is pressed, the camera records videos under the control of the CPU, the camera control unit converts the recorded videos into electrical signals and sends the electrical signals to the CPU, the CPU sends the electrical signals to the Bluetooth unit, the Bluetooth unit converts the electrical signals into Bluetooth signals and transmits the Bluetooth signals.

9. A vehicle data recorder system comprising:
a vehicle data recorder comprising:
a main body comprising a main portion, a connection rod, and an earphone, the main portion connected to the connection rod, the earphone extending from a free end of the connection rod; and
a fixing element fixed to the main portion and a free end of the fixing element is spaced from the main portion; and
a portable electronic device;
wherein videos recorded by the vehicle data recorder are sent to the portable electronic device for storage.

10. The vehicle data recorder system as claimed in claim 9, wherein the fixing element comprises a fixing portion and an elastic portion, the fixing portion is perpendicularly connected to the elastic portion.

11. The vehicle data recorder system as claimed in claim 10, wherein the elastic portion is made of elastic material.

12. The vehicle data recorder system as claimed in claim 10, wherein the fixing portion is fixed to the main portion, and then the elastic portion is spaced from the main portion.

13. The vehicle data recorder system as claimed in claim 9, wherein an angle between the main portion and the connection rod is an obtuse angle, the earphone extends from a free end of the connection rod and the earphone is perpendicular to an inner side surface of the connection rod.

14. The vehicle data recorder system as claimed in claim 9, wherein the main portion comprises an end wall and a peripheral wall connected to the peripheral wall; a camera is located on the end wall and a button is located on the peripheral wall.

15. The vehicle data recorder system as claimed in claim 14, further comprises a central processing unit (CPU), a camera control unit, an earphone control unit, and a Bluetooth unit; the CPU, the camera control unit, the earphone control unit, and the Bluetooth unit are received in the main portion; the button, the camera control unit, the earphone control unit, and the Bluetooth unit are electronically connected to the CPU.

16. The vehicle data recorder as claimed in claim 15, wherein when the button is pressed, videos are recorded by the camera under the control of the CPU, the camera control unit converts the videos into electrical signals, the electrical signals are sent to the CPU, the CPU then sends the electrical signals to the Bluetooth unit, the Bluetooth unit converts the electrical signals into Bluetooth signals and transmits the Bluetooth signals.

17. A method for utilizing the vehicle data recorder system as claimed in claim 9, comprising steps of:
establishing a communication between the vehicle data recorder and the portable electronic device;
causing the vehicle data recorder to record and send videos as Bluetooth signals to the portable electronic device;
determining if the vehicle data recorder is still recording, if it is, causing the portable electronic device to store the video; if not, the vehicle data recorder determines that a recording time of the vehicle data recorder is not less than a maximum time of the videos can be stored in the portable electronic device, the vehicle data recorder sends an alarm signal to the portable electronic device, and the portable electronic device cancels a first hour video stored in the portable electronic device according to the alarm signal.

18. The method as claimed in claim 17, wherein if the recording time is less than the maximum time, the portable electronic device stores the videos received from the vehicle data recorder.
